(19) United States
(12) Patent Application Publication
(10) Pub. No.: US 2013/0036665 A1
(43) Pub. Date: Feb. 14, 2013

(54) RETAINING MEANS FOR TRAINING VINES

(71) Applicant: Otto Winterleitner, Feldkirchen (AT)

(72) Inventor: Otto Winterleitner, Feldkirchen (AT)

(21) Appl. No.: 13/580,297

(22) PCT Filed: Jan. 21, 2011
(86) PCT No.: PCT/AT11/00038

§ 371 Date: Oct. 19, 2012

(30) Foreign Application Priority Data
Feb. 22, 2010 (AT) A 262/2010

(51) Int. Cl. A01G 17/08; F16B 2/20

(52) U.S. Cl. 47/44; 47/58.1 R; 24/518; 24/456

(57) ABSTRACT

The invention relates to a device for attaching retaining means or clips to guide means, in particular strings, for training vines, as well as retaining means for this device. In order to achieve increased cycle frequency with a high degree of automation and economy with an attachment of retaining means to guide means, it is provided according to the invention that the device is formed with at least one reservoir, a magazine or a like part for the sequential provision of open retaining means and/or retaining means formed with two half shells and a device connected thereto for closing the half shells of the retaining means while fixing the same to the guide means and enclosing the vine.

The invention relates to a device for attaching retaining means or clips to guide means, in particular strings, for training vines.

Furthermore, the invention relates to a method for attaching retaining means or clips to guide means, in particular to strings, for training vines.

The invention also relates to a retaining means or clip for training vines on a guide means, in particular on a string, composed of two half shells, which are connected to one another by means of a film hinge with a clamping device for a guide means and at the ends has a locking connection composed of cooperating parts, wherein the half shells in the closed state form a guide hollow for a vine and the half shells in the axial direction of the hollow in cross section have two flange parts essentially of a cylindrical center part and continued outwards with rounded transitions.

Finally, the invention relates to a means for the sequential provision of open retaining means for vines formed by two half shells.

Retaining means or clips for training shoots are used in nurseries, tree nurseries, plantations, for example, in greenhouses and the like with plant cultivation, wherein the vines during their growth are guided along by training means.

Retaining means in a variety of embodiments and for different training means or plant supports are known.

The above-mentioned retaining means are essentially composed of two half shells or the like elements, which can be joined and connected to one another and in this manner form an opening or a hollow in which a growing vine of a plant is accommodated and can be guided in a desired direction. A plurality of retaining means have, in addition to the hollow, a fastening part or a clamp for a guide means, optionally for a string, in order to achieve a positioning of the clip for the desired training or desired guidance of the vine.

In order, for example, to be able to attach a retaining means or clip in a desired position to a string leading essentially upwards, it is known to embody the half shells of the same connected at one end to a film hinge and adjacent thereto to provide a clamping region, wherein parts for the locking connection are shaped at the opposite end of the half shells. With a closing of the half shells, a closing of the clamping region also takes place so that in this manner the retaining means can be fixed or clamped in a slip-resistant manner in a desired position laterally on the string.

Retaining means are usually component parts with open half shells, which are optionally provided in bundles or sacks for removal for a person fastening the vine ends. According to an essentially predetermined vine height, an open retaining means is now respectively removed from the provision, positioned on the guide means with the vine and joined by hand, wherein the locking closure produces a connection of the half shells.

In the case of a plantation, for example, in which a plurality of vines, in particular vine fruit plants such as peppers, tomatoes, cucumbers and the like, are cultivated and the shoots are guided according to the growth, this training of the same on guide means by the attachment of retaining means entails a high expenditure in terms of labor and time.

One object of the invention lies in creating a device of the type mentioned at the outset, by means of which retaining means or clips can be attached to guide means for training vines in a simple manner and with high cycle frequency.

A further object of the invention lies in disclosing a method for attaching retaining means to guide means, which method has a high degree of automation.

The invention also has the object of producing a retaining means or clip which has a high functional reliability and is easy to use.

A further object of the invention lies in the creation of a means for the sequential provision of open retaining means formed by two half shells for vines, which in use guarantees high cost-effectiveness.

The object set is attained in that the device is formed with at least one reservoir, a magazine or a like part for the sequential provision of open retaining means and/or retaining means shaped with half shells and a device connected thereto for closing the half shells of the retaining means while fixing the same to the guide means and enclosing the vine.

The advantages achieved with the invention are essentially to be seen in that by means of the device the retaining means with open half shells are respectively brought into a working position and can be fixed securely to the guide means with a device in this apparatus. Manual work is thereby limited only to triggering the provision and a tool-connected closing of the retaining means, which can take place within a short time.

A preferred embodiment of the device is produced in that the part for the sequential provision of opened retaining means or clips formed with two half shells and connected by means of a film hinge is formed as a guide channel with an infeed means that can be controlled by the closing device, and separation means for retaining means arranged in a row next to one another and connected to one another to form a clip chain. In this manner a sequential provision of the retaining parts can be designed in a simplified manner and can take place at high speed and with great reliability.

If the device is formed with manual operation or with controllable activation means, and the mechanism for an infeed and the sequential provision of the open retaining means and the device for closing the half shells of the same as well as the release thereof are actively connected, a safe overall function of the same can be achieved.

A simple and extremely precise attachment of a retaining means to the guide means is achieved with a preferred embodiment of the invention in that the device in a connection region of the retaining means positioned opened in the closing region of the device perpendicular to the closing plane has at least one, preferably two, distanced depression(s) or one, preferably two, blind slot(s) in the housing for guiding and providing the guide means in the closure region or for the guided placement of the same has a film hinge of the open retaining means.

For a simple use, in particular in the case of an attachment of retaining means for vines on essentially vertical training means, it is favorable if this device has a retaining part, in particular a device part that can be grasped by a human hand, preferably in a pistol-grip shape, and a lever for triggering and/or executing the closing operation of the half shells of the retaining means, wherein the closing plane or the plane in which the half shells are moved during the closure of the retaining means,is positioned essentially at a right angle to the longitudinal extension of the retaining part or handle part.

The further object of the invention is attained with a method of the type mentioned at the outset in that in a device with the activation of the same from a reservoir, a magazine or a like part respectively a retaining means in the opened state ready for closure is inserted into a device and for a closing of the retaining means parts is positioned thereby, after which by means of the guidance of the device, a guide means is brought into position perpendicular to the closing plane or the movement plane in a connecting region of the retaining means parts or is placed against the film hinge of the opened retaining means and a vine is held spaced apart from the guide means, whereupon by further actuation of a closing mechanism the retaining means parts are connected to one another and in this manner the retaining means is fixed to the guide means and a training of a vine is formed, and in a continuation of the method with an opening of the closing mechanism of the device, the retaining means is released and as a result, optionally after a severing of a connection forming a clip chain, an insertion of a further opened retaining means from the reservoir supply into the opened closing device takes place.

Essential advantages obtained with the invention are to be seen in that in this manner the greatest possible degree of automation can be achieved while fixing a clip to a guide means and the quality of the attachment has a constant high quality.

The object according to the invention of producing a retaining means reliable in operation and with the best processing properties, is attained if the contour transverse to the hollow axial direction of the parts of the locking connection of both ends of the half shells in the open state of the retaining means is shaped identically.

In an advantageous manner it is achieved by this geometric embodiment that the open half shells of the retaining means, regardless of the position of the locking hook or the locking strip, can be brought into the device for closing the same.

If according to a preferred embodiment of the retaining means, the half shells in the region of the half shell arc length between the flange parts preferably flush with the outer contour of the flanges have webs connecting them, on the one hand a safe engagement of the parts of the closing mechanism is achieved when the half shells are brought together and on the other hand the stability of the clip is increased with lateral load.

If furthermore according to a preferred embodiment of the invention it is provided that two centering tabs are arranged lying opposite outside on the half shells adjacent to the film hinge, the clip is thus held in position in the device. After placing the guide means or the string against the film hinge, a bending of the half shells occurs, wherein the centering tabs cause an enclosure of the string and the retaining means is subsequently released.

The further object of the invention is attained with a generic means in that identical open retaining means in a row spaced apart from one another are connected by connecting webs, in particular two webs, and form a chain, optionally a magazine chain, wherein the connecting webs are arranged on a line perpendicular to the desired bending line of the magazine chain.

The advantages according to the invention achieved thereby are essentially to be seen in that a chain of open retaining means connected to one another itself represents a magazine or a reservoir without a replaceable magazine housing for a provision being necessary. The magazine chain is optionally inserted into the device with a guide, wherein the first clip snaps into a catch holder and as a result is ready for assembly.

Based on drawings, which represent only one embodiment of the invention, this is to be explained in greater detail.

They show:

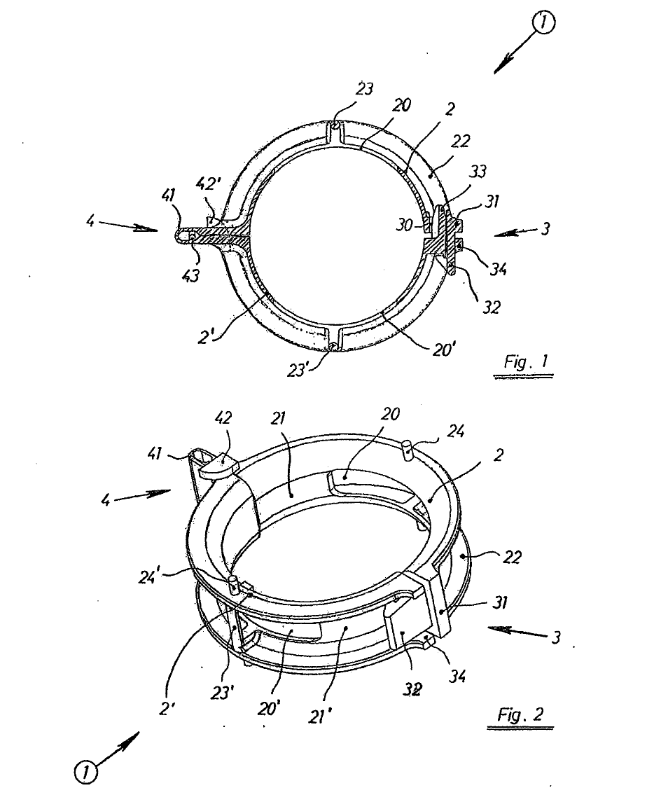

FIG. 1 a retaining means in plan view

FIG. 2 a retaining means

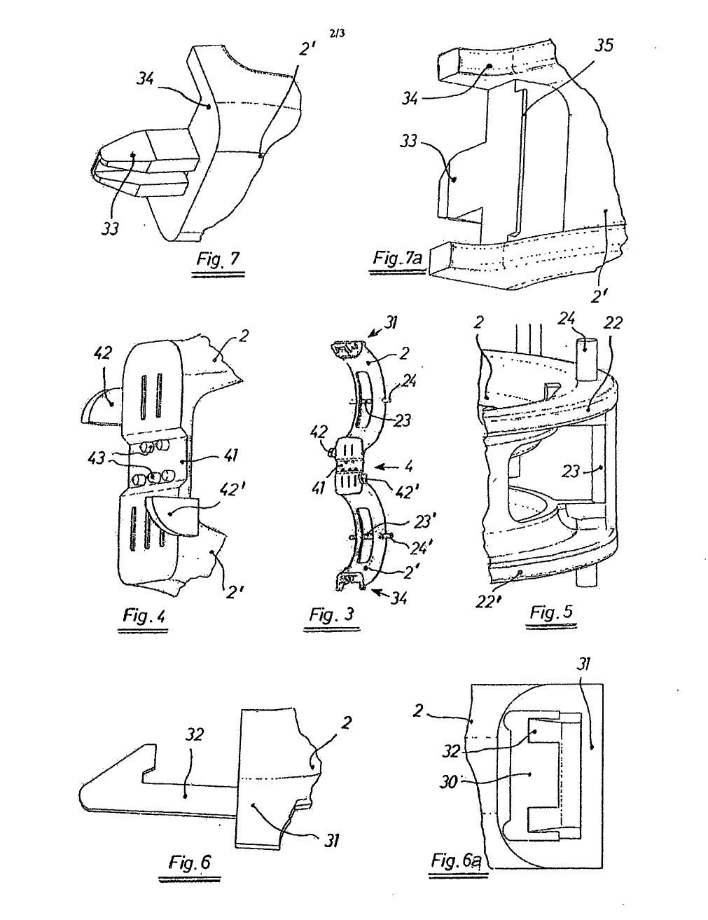

FIG. 3 an open retaining means

FIG. 4 a film hinge

FIG. 5 a side part of a half shell

FIG. 6 a locking hook

FIG. 6a a pair of locking hooks

FIG. 7 a locking guide

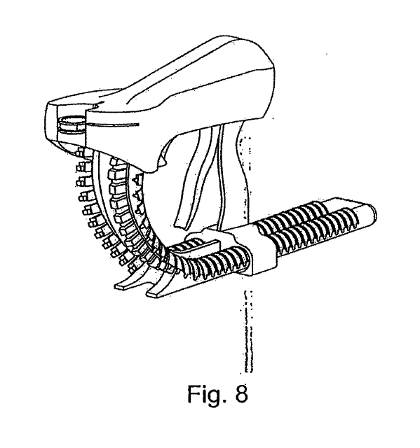

FIG. 8 a device for attaching retaining means

FIG. 7a a locking strip

FIGS. 2 through 8 are oblique view representations

The following list of reference numbers is intended to facilitate the overview with the description of parts:

1 retaining means or clip

2.2′ half shells

20, 20′ opening

21, 21′ cylinder part

22, 22′ flange part

23, 23′ flange web

24, 24′ connecting web

3 locking connection

30 guide hollow

31 locking hook outer part

32 locking hook

33 pilot pin

34 snap-in part

35 snap-in strip

4 film hinge

41 bending area

42, 42′ centering tabs

43 clamping means

In FIG. 1 a retaining means or clip 1 with closed half shells 2, 2′ is shown in section transversely to the hollow axis. FIG. 2 shows a closed retaining means in oblique view.

For training growing vines, the half shells 2, 2′ have respectively a cylinder part 21, 21′ forming a hollow with flange parts 22, 22′ directed outwards on both sides. In the region of the ends of the half shells 2, 2′on the one hand a locking connection 3 and on the other hand a film hinge 4 lying opposite this are shaped thereon.

In a half arc length of the half shells 2, 2′ the cylinder parts 21, 21′ each has an opening 20, 20′, wherein in the region of the center of the openings the flange parts 22, 22′ are connected on the outside by means of a flange web 23.

The locking connection 3 is formed with a locking hook part 31 with a guide hollow 30 and two locking hooks 32 on one half shell end and a snap-in part 34 with a pilot pin 33 and a snap-in strip 35 on the other half shell end, wherein in the closed state of the connection the pilot pin 33 projects into the guide hollow 30 and the locking hooks 32 bear against the snap-in strip 35.

In the axial direction of the guide hollow 30 for the vine or in plan view of the retaining means or the clip 1, based on the connecting area of the half shells 2, 2′, the locking hook outer part 31 and the snap-in part 34 have the same contour.

Opposite the locking connection 3, the half shells 2, 2′ are connected to one another by a film hinge 4.

The bending area 41 of the film hinge 4 is positioned outside the flange parts 22, 22′, a clamping means 43 for a guide means for the slip-proof fixing of the retaining means 1 thereon.

At the ends of the flange parts 22, 22′ respectively one centering tab 42, 42′ is arranged thereon lying opposite outside, by means of which when the half shells 2, 2′ are closed, a guide means, for example a string, can be enclosed in the region of the clamping means.

Connecting webs 24 leading away from the flange parts 22, 22′ of a retaining means 1 serve to form a magazine with a plurality of open retaining means arranged one after the other and connected to one another.

FIG. 3 shows a retaining means 1 with opened half shells 2, 2′, which are connected by a film hinge 4.

The bending area 41 has clamping means 43, which with closed half shells 2, 2′ fix the retaining means 1 on the training means. In order to ensure a clamping of the guide means free from displacement in the region of the bending area 41, respectively one centering tab 42, 42′ is arranged on the half shells 2, 2′ lying opposite on the outside, which centering tabs with a closing of the half shells 2, 2′ enclose the guide means in the region of the clamping means 43.

With an open position of the retaining means 1 in a device according to the invention, to close the half shells 2, 2′ the centering tabs 42, 42′ can also act as detention parts in the first part of the closing operation. A closing operation itself up to a joining of the locking hook outer part 31 and the snap-in part 34 is carried out by guide arms acting on flange webs 23, 23′, which guide arms preferably are path-controlled or gate-controlled.

A magazine formation is achieved by means of combining a plurality of open retaining means 1 by connecting webs 24, 24′.

FIG. 4 shows a film hinge 4 in enlarged representation.

FIG. 5 illustrates with improved clarity a central region of a half shell 2 with a flange web 23 arranged on the outside between the flange parts 22, 22′.

In FIG. 6 and FIG. 6a respectively the locking hook outer part 31 with a guide hollow 30 and with the protruding locking hook 32 of a locking connection 3 are shown in an oblique view representation, wherein this can have a securing flute for the snap-in strip 35.

In FIG. 7 and FIG. 7a the snap-in part 34 with a pilot pin 33 and a snap-in strip 35 of a locking connection 3 can be seen in the oblique view representation.

FIG. 8 shows an operational device for attaching and closing retaining means or clips. A blind slot for guiding a guiding means or a string for placement on a film hinge of a retaining means are embodied on the top of the housing. The retaining means are provided from a magazine chain.

1. A device for attaching retaining means or clips to guide means, in particular to strings, for training vines, characterized in that the device is formed with at least one reservoir, a magazine or a like part for the sequential provision of open retaining means and/or retaining means shaped with two half shells and a device connected thereto for closing the half shells of the retaining means while fixing the same to the guide means and enclosing the vine.

2. The device according to claim 1, characterized in that the part for the sequential provision of opened retaining means or clips formed with two half shells and connected by means of a film hinge is formed as a guide channel with an infeed means that can be controlled by the closing device, and separation means for retaining means arranged in a row next to one another and connected to one another to form a clip chain.

3. The device according to claim 1 or 2, characterized in that this device is formed with manual operation or with controllable activation means, and the mechanism for an infeed and the sequential provision of the open retaining means and the device for closing the half shells of the same as well as the release thereof are actively connected.

4. The device according to one of claims 1 through 3, characterized in that this device in a connection region of the retaining means positioned opened in the closing region of the device perpendicular to the closing plane has at least one, preferably two, distanced depression(s) or one, preferably two, blind slot(s) in the housing for guiding and/or providing the guide means in the closure region or for the guided placement on a film hinge of the retaining means.

5. The device according to one of claims 1 through 4, characterized in that this device has a retaining part, in particular a device part that can be grasped by a human hand, preferably in a pistol-grip shape, and a lever for triggering and/or executing the closing operation of the half shells of the retaining means, wherein the closing plane or the plane in which the half shells are moved during the closure of the retaining means, is positioned essentially at a right angle to the longitudinal extension of the retaining part or handle part.

6. A method for attaching retaining means or clips to guide means, in particular to strings, for training vines, characterized in that in a device with the activation of the same from a reservoir, a magazine or a like part respectively a retaining means in the opened state ready for closure is inserted into a device and for a closing of the retaining means parts is positioned thereby, after which by means of the guidance of the device, a guide means is brought into position perpendicular to the closing plane or the movement plane in a connecting region of the retaining means parts or is placed against the film hinge of the opened retaining means and a vine is held spaced apart from the guide means, whereupon by further actuation of a closing mechanism the retaining means parts are connected to one another and in this manner the retaining means is fixed to the guide means and a training of a vine is formed, and in a continuation of the method with an opening of the closing mechanism of the device, the retaining means is released and as a result, optionally after a severing of a connection forming a clip chain, an insertion of a further opened retaining means from the reservoir supply into the opened closing device takes place.

7. Retaining means or clip (1) for training vines on a guide means, in particular on a string, composed of two half shells (2, 2′), which are connected to one another by means of a film hinge (4) with a clamping device (41) for a guide means and at the ends has a locking connection (3) composed of cooperating parts, wherein the half shells (2, 2′) in the closed state form a guide hollow for a vine and the half shells (2, 2′) in the axial direction of the hollow in cross section have two flange parts (22, 22′) essentially of a cylindrical center part and continued outwards with rounded transitions, characterized in that the contour transverse to the hollow axial direction of the parts (31, 34, 32, 33) of the locking connection (3) of both ends of the half shells (2, 2′) in the opened state of the retaining means (1) is shaped identically.

8. The retaining means (1) according to claim 7, characterized in that the half shells (2, 2′) in the region of the half shell arc length between the flange parts (22, 22′) preferably flush with the outer contour of the flanges have webs (23, 23′).

9. The retaining means according to claim 7 or 8, characterized in that two centering tabs (42, 42′) are arranged lying opposite outside on the half shells (2, 2′) adjacent to the film hinge (4).

10. Means for the sequential provision of open retaining means (1) for vines formed by two half shells (2, 2′), characterized in that identical open retaining means (1) in a row spaced apart from one another are connected to one another by connecting webs (24), in particular two webs (24, 24′) and form a chain, optionally a magazine chain, wherein the connecting webs (24, 24′) are arranged on a line perpendicular to the desired bending line of the magazine chain.
